(19) United States
(12) Patent Application Publication
(10) Pub. No.: US 2014/0338779 A1
(43) Pub. Date: Nov. 20, 2014

(54) METHOD FOR PRODUCING TUBULAR BODIES FOR PACKAGING TUBES, AND A PACKAGING TUBE WITH A TUBULAR BODY

(71) Applicant: Julius Läubli, Rapperswil (CH)

(72) Inventor: Julius Läubli, Rapperswil (CH)

(21) Appl. No.: 14/126,473

(22) PCT Filed: Jun. 5, 2012
(86) PCT No.: PCT/EP2012/060572

§ 371 Date: Mar. 27, 2014

(30) Foreign Application Priority Data
Jun. 16, 2011 (DE) 10 2011 051 108.3

(51) Int. Cl. B65D 5/56; B29C 65/02; B31C 5/00

(52) U.S. Cl. CPC B65D 5/56; B31C 5/00; B29C 65/02; B29L 2016/00
USPC 138/141; 493/291

(57) ABSTRACT

A method for manufacturing tubular bodies (1) exhibiting an inner circumferential surface and outer circumferential surface (8) for packaging tubes out of a strip-shaped film substrate (2) that encompasses a barrier layer (19) against moisture and/or oxygen, exhibits at least one weldable plastic layer (3), and comprises a beveled first edge face (5) extending in the longitudinal direction of the film substrate (2) and a beveled second edge face (6) spaced apart from the first edge face (5) by the width of the film substrate (2), wherein the first edge face (5) and second edge face (6) are arranged opposite each other with the formation of a tube shape, and welded together during exposure to heat, the first and second edge face (5, 6) are pressed against each other during welding so as to compress the barrier layer (19), accompanied by the formation of a wave geometry encompassing several wave peaks and/or several wave valleys and exhibiting at least three zero crossings and/or at least two equiphase zero crossings.

### BACKGROUND OF THE INVENTION

The invention relates to a method for manufacturing tubular bodies exhibiting an inner circumferential surface and outer circumferential surface for packaging tubes out of a strip-shaped film substrate encompassing a barrier layer, as well as to a packaging tube encompassing a tubular body preferably manufactured using a method according to the invention, along with a tubular head fixedly joined with the tubular body.

Known from JP 8 001 838 A is a method for manufacturing tubular bodies exhibiting an inner circumferential surface and outer circumferential surface for packaging tubes out of a strip-shaped film substrate encompassing a barrier layer, wherein two edge faces of the film substrate are pressed against each other during welding so as to deflect the barrier layer relative to an imagined zero line. The known tubular body would appear to be in need of improvement with respect to the safety and robustness of the weld seam.

JP 2005 239 199 A also shows a tubular body for tubes in which the end of the barrier layer is deflected from the area of a zero line. The bond between the edge faces would appear to be in need of improvement here as well.

Known from WO 2007/113781 A2 is a tubular body for packaging tubes. The tubular body of the known packaging tube is manufactured by having two edge faces oriented at a right angle relative to the outer circumferential surface abut flush against each other, and then providing the outer circumferential surface with a sealing tape that is separate from the film substrate forming the tubular body, and used to fix (weld) the film substrate to the aforementioned tube shape. The disadvantage to the known packaging tube is that an additional material in the form of a sealing tape must be used for welding the film substrate or manufacturing the tubular body, which also appears visually bulky. As an alternative to arranging the sealing tape on the outer circumferential surface, the aforementioned publication describes providing the sealing tape on the interior side, with the danger of cracking in the actual film substrate. In addition, manufacture is comparatively complicated and material-intensive because a separate sealing tape is used.

Known from CH 686 665 A5 is a method for manufacturing a tubular body for a packaging tub, in which non-beveled edge faces of the film substrate are placed against each other, after which the film substrate is welded together. As opposed to the aforementioned prior art, the described method does without separate sealing tape. The disadvantage to the known tube is the comparatively small contact surface (welding surface).

Known from DE 41 21 427 C2 is an alternative method for manufacturing a tubular body. Shown therein on FIG. 8 is an exemplary embodiment, in which the opposing, longitudinally extending edge faces of a strip-shaped film substrate to not run at a right angle to the outer circumferential surface, but rather have a beveled design, wherein the edge faces are placed against each other in such a way that the edge faces line up precisely radially outward, i.e., two adjacent outer circumferential surface sections seamlessly converge in the circumferential direction or lie on the same radius prior to welding. In this state, the edge faces are then welded together by being sandwiched between two sealing strips. Tubular bodies manufactured in this way have proven themselves. One positive aspect to be emphasized in particular is that the known method makes do without additional sealing tape. The contact surfaces are also comparatively large. However, efforts are underway to further improve the bond, in particular the welded seam between the edge faces, especially in terms of robustness and with respect to an even lower permeability to moisture and/or oxygen. Defective welds are preferably to be avoided in a radially outer region of the abutting edge faces, more precisely in a border region between the edge faces leading linearly to the outside, so as to thereby reliably prevent a packaging tube from undesirably bursting or spontaneously opening in the area of the welded seam.

Known from JP 8 091 397 A is a packaging tube with a tubular pipe made out of a laminate substrate, wherein the depiction on FIG. 2 reveals a slight displacement of a dyed film in a contact area of two edge faces welded to each other. The metallic barrier layer labeled with reference number 3 overlaps itself without contact in the circumferential direction, wherein a left end in the drawing plane is upwardly displaced, and a right end in the drawing plane is downwardly displaced.

### SUMMARY OF THE INVENTION

Proceeding from the aforementioned prior art, the object of the invention is to indicate an improved method for manufacturing tubular bodies for packaging tubes, which does without additional sealing tape, and also ensures a better (more robust and reliable) bond between the edge faces of the tubular body, while at the same time providing optimal barrier properties.

The object further lies in indicating a correspondingly improved, in particular more robust packaging tube and good barrier properties.

This object is achieved with the features of the method, and of the packaging tube as disclosed herein. Advantageous further developments of the invention are indicated as well. All combinations of at least two features disclosed in the specification, claims and/or figures fall within the framework of the invention. To avoid repetition, features disclosed for the device are also to be regarded as disclosed for the method and claimable. Likewise, features disclosed for the method are to be regarded as disclosed for the device and claimable.

The invention is based on the idea of pressing the opposing, beveled edge faces together in such a way, in particular while hardening or cooling the weld seam, preferably up until solidification after the welding process, that at least sections of at least the one barrier layer are compressed so as to form a (permanent) wave geometry, which encompasses several wave valleys and/or several wave peaks. Compression in a circumferential direction and the resultant wave geometry of the barrier layer surprisingly increase the robustness of the packaging tube, and the sealing properties are improved with respect to the passage of gas and/or moisture, in particular in the welding area. For example, the barrier layer can be comprised of at least one metal film or plating, and/or at least one plastic barrier layer, e.g., EVOH, PA, PETG.

In particular while hardening or cooling the weld seam, it has proven especially advantageous to press the edge faces together in a circumferential direction with a force per contact surface ranging between 0.1 bar and 4 bar, preferably between 0.2 bar and 1 bar, which can be achieved by corresponding guide plates, for example. The pressure selected in the circumferential direction is preferably higher prior to melting than the values specified above.

As mentioned at the outset, the wave geometry preferably encompasses several wave valleys and/or several wave peaks, wherein a wave valley in the circumferential direction is followed by a wave peak, with it being especially preferred that the radial deflection of adjacent wave peaks and wave valleys in the circumferential direction decrease with increasing distance to the compression site or welding site (diminishing amplitude).

In a departure from the instruction in DE 41 21 427 C2, a further development of the invention advantageously provides that the beveled edge faces not be arranged flush in such a way that the opposing edge faces end on the same radius relative to a longitudinal axis of the tubular body, but rather in such a way that the first of the two edge faces projects over the outer circumferential surface of the tubular body in a circumferential direction (to a certain extent) prior to the welding process, a diagonally outwardly opening longitudinal gap with preferably an essentially triangular cross section forms between this first edge face displaced somewhat more radially outward and the outer circumferential surface of the tubular body immediately adjacent to the second edge face. Expressed differently, the radially oriented, vertically displaced (radially displaced) arrangement of the two beveled edge faces from the radially outer area of the first edge face forms a kind of overhanging tip, which is located above the outer circumferential surface of the tubular body, thereby yielding an elongated groove or receptacle, i.e., longitudinal gap. In the welding step that follows the aforementioned positioning step, this outer longitudinal gap is filled with plastic material, in particular the aforementioned tip, resulting in a soft, i.e., edgeless or seamless transition, which covers the boundary surface between the adjoining edge faces in a radially outer area, and thereby reliably prevents the two edge faces from detaching from each other. In addition, the imagined boundary surface between the two beveled, abutting edge faces does not continue linearly up to the outer circumference as in prior art, but rather is sealed by the transitional section. This results in a tighter packaging tube, which on top of that is more robust. The improved method does without additional sealing tape, making it economical in terms of material and surprisingly simple, since the longitudinal gap to be subsequently filled with plastic material can be obtained comparatively easily by placing the two beveled edge faces side by side, but not in a flush or vertically displaced manner.

The initially strip-shaped film substrate is preferably converted into the tubular body or tube shape in a known manner, for example via molding strips, which are driven by concavely contoured rollers, for example as depicted in CH 686 665 A5.

The method according to the invention also makes it possible to mold asymmetrically structured film substrates into a tubular body for packaging tubes without the use of additional sealing material.

A wave geometry is here understood as a periodic geometry, i.e., a geometry that proceeds in a circumferential direction in the form of at least two wave peaks and/or at least two wave valleys, wherein adjacent wave peaks and valleys do not necessarily have to exhibit the same longitudinal or circumferential extension. In other words, the wavelength can vary in a circumferential direction, in particular with the wavelength (distance between two wave peaks adjacent in the circumferential direction or between two wave valleys spaced apart in the circumferential direction) becoming larger. One indicator for the presence of periodicity, and hence a wave geometry in the sense of the invention, is when at least three zero crossings exist between an imagined zero line preferably lying on a radius and extending in the circumferential direction, wherein the wave geometry preferably exhibits two equiphase, i.e., two ascending or two descending flanks or zero crossings.

In addition to the aforementioned outer longitudinal gap in the area of the inner circumference of the tubular body to be manufactured, it is especially preferred that the beveled edge faces be placed against each other to also form an inner longitudinal gap, which is preferably displaced in the circumferential direction to the outer longitudinal gap, and even further preferred is also filled with plastic material in the welding step following the positioning step, so that a beveled or non-stepped transitional section is also formed in the interior area between the vertically displaced inner circumferential surface sections spaced apart in the circumferential direction that did not melt during the welding process. Therefore, this embodiment realizes not just a transitional section between vertically displaced outer circumferential surface sections after the welding process, but similarly an inner transitional section.

It has proven especially advantageous for the first edge face and second edge face to be arranged relative to each other in such a way that the first edge face projects over the outer circumferential surface, more precisely the outer circumferential surface adjacent to the second edge face or adjoining the latter, by a specific distance ranging between 0.01 mm and 1.50 mm, preferably between 0.05 mm and 1.00 mm. The second edge face preferably also projects over the inner circumferential surface adjacent to the first edge face by a distance within the above ranges, especially preferably by the same distance that the first edge face projects over the outer circumferential surface adjacent to the second edge face in the circumferential direction.

It is especially preferred that the first and second edge face be vertically displaced (radially displaced) relative to each other in such a way that the barrier layer projects over, i.e., overlaps, itself with at least one segment in the circumferential direction, since this makes it possible to improve the permeability of the packaging tube to moisture and/or oxygen even further. It is especially preferably preferred that the edge faces be arranged relative to each other in such a way that one radially outer boundary (longitudinal edge, longitudinal boundary) of a barrier layer edge face extending in the longitudinal direction of the film substrate (and forming a portion of the first edge face) be spaced apart from a radially inner boundary of a second barrier layer edge face (forming a section of the second edge face) in the radial direction by a distance ranging between 10 μm and 300 μm, preferably between 20 μm and 250 μm.

There are here various options for the relative arrangement of the two barrier layer edge faces (as a function of thickness ratios). For example, the two barrier layer edge faces can be spaced apart in the radial direction, border each other directly in a radial direction, or overlap to a certain extent in the radial direction.

With respect to an improved tightness, it has proven especially beneficial for the first and second edge face to be pressed against each other in a circumferential direction so as to compress the barrier layer, at least in the bonding area of the film substrate, preferably with the formation of a wave geometry. The pressure required for this purpose essentially depends on the nature of the film substrate, i.e., its diameter or thickness (layer thickness) and/or layer composition.

As mentioned at the outset, the formation of the outer and/or inner longitudinal gap can be realized by having the two edge faces not abut flush against each other outside, but instead be vertically displaced in a radial direction. What this means, then, is that the thickness centers of the beveled, abutting edge faces are spaced apart in a radial direction, preferably by a distance ranging between 10 μm and 300 μm, preferably between 20 μm and 250 μm. This then leads to a vertical displacement of the first outer circumferential surface edge section adjacent to the first edge face relative to the second outer circumferential surface edge section adjacent to the second edge face.

As mentioned at the outset, both edge faces are beveled, i.e., run at an angle to the direction of extension of the film substrate thickness different than 90°. The selected first angle at which the first edge face runs relative to the thickness extension direction can conceivably differ from the second angle formed by the second edge face with the thickness extension direction relative to the direction of thickness extension. As an alternative, it is possible for the first and second angle to be at least approximately identical. Both the first angle and second angle are preferably selected from an angular range of between 1° and 80°, preferably between 5° and 70°, even more preferably between 10° and 60°. The thickness extension direction involves a thickness extension direction at a circumferential position that the direction of thickness extension borders at one of the edge faces, or at least intersects one of the edge faces. Alternatively, it can also be assumed that the thickness extension direction for the film substrate in a flat (planar), unwound state is involved.

The edge faces are preferably designed as a straight section angled relative to the outer circumference, i.e., extend flatly or linearly from the outer to inner circumference.

As also mentioned at the outset, the method according to the invention enables the use of both film substrates that are symmetrical to an imagined central plane, as well as asymmetrical substrates, wherein the film substrate preferably consists either of sealable, particularly thermoplastic plastic, for example polyethylene, polypropylene, or copolymers thereof. As an alternative, at least one (weldable) plastic layer is provided, in particular made out of the aforementioned material, which even more preferably forms an outer layer of the film substrate. The weldable plastic film is preferably paired with a barrier layer, for example an EVOH layer.

The invention also presents a packaging tube, which apart from the tubular body encompasses a tubular head (with outlet) secured to the tubular body in a known manner. It is especially preferred that the tubular body of the packaging tube be manufactured using a method explained in detail above and designed based on the concept of the invention, wherein at least the tubular body (tube body) is manufactured by welding the film substrate to itself. The invention provides that the barrier layer exhibit a wave geometry, in particular owing to compression while welding and/or during hardening or solidification of the weld seam, i.e., preferably at least one radially inward deflection (wave valley) and a radially outward deflection (wave peak) adjacent in the circumferential direction.

It is especially preferred that there be several alternating wave peaks and wave valleys, wherein their amplitude preferably diminishes as the distance from the weld seam increases. It has proven especially advantageous that the selected wavelength for the wave geometry in at least one section, preferably one adjacent to the welding area, range between 200 μm and 1800 μm, preferably between 400 μm and 1000 μm, eminently preferably between 500 μm and 700 μm, with it being eminently preferred that the wavelength measure about 670 μm. The wavelength is here understood as the distance between the minimums for two consecutive wavelengths in the circumferential direction, or the distance measured in the circumferential direction between the maximums for two wave peaks adjacent in the circumferential direction, wherein a wave peak is formed between two wave valleys, or a wave valley is formed between two wave peaks.

It especially makes sense for the selected deflection (amplitude) for at least one wave valley or one wave peak relative to a(n imagined) zero line (zero line diameter) around which the barrier layer undulates to range between 15 μm and 45 μm, preferably between 20 μm and 30 μm. It especially makes sense for double this deflection, i.e., the distance between a maximum for a wave peak and the minimum for a wave valley immediately adjacent in the circumferential direction, to range between 30 μm and 90 μm, preferably between 40 μm and 70 μm.

A further development of the invention advantageously provides that a first (preferably not melted when welding, i.e., exhibiting its original shape) outer circumferential surface section of the tubular body be spaced apart in a radial direction from a second (preferably also not melted when welding, i.e., exhibiting its original shape) outer circumferential surface section, wherein the two aforementioned outer circumferential surface sections vertically displaced viewed in a radial direction have formed between them an outer transitional section comprised of melted plastic layer material, with which a(n inclined) continuous transition in the circumferential direction is formed between the outer circumferential surface sections.

This transitional section is preferably generated by melting an overhanging tip of a first edge face of the film substrate, which projected over an outer circumferential surface edge section bordering the second edge face prior to welding, with the formation of an outer longitudinal gap.

In analogous fashion, the inner circumference of the packaging tube is preferably provided with one such (then inner) transitional section between two inner circumferential surface sections spaced apart in a radial direction.

It is especially preferred that the aforementioned outer transitional section project over a connecting area formed between edge faces of the film substrate or a boundary surface between these two edge faces in the circumferential direction, so that this boundary area does not continue linearly outward. It is preferred that the aforementioned boundary area additionally be covered on the inner circumference by means of the inner transitional section.

It is eminently preferred that the outer transitional section consist exclusively of melted plastic layer material of the film material, in particular an outermost plastic layer. In analogous fashion, an inner transitional section, if provided, preferably consists exclusively of melted plastic layer material of the film substrate, in particular an innermost plastic layer.

As disclosed within the framework of the method, it makes sense especially for the film substrate to encompass at least one barrier layer against moisture and/or oxygen, wherein the barrier layer exhibits a first barrier layer edge face belonging to the first edge face, and a second barrier layer edge face belonging to the second edge face, wherein the latter are oriented or directed in opposite circumferential directions, analogously to the edge faces.

It makes sense especially for the barrier layer (i.e., their ends pointing in opposite circumferential directions) to overlap to a certain extent in the circumferential direction, preferably over a distance within a range disclosed in conjunction with a preferred embodiment of the method. It is eminently preferred that the barrier layer be compressed, preferably undulated, in the packaging tube as well, in particular by pressing together the edge faces of the film substrate during manufacture and subsequent fixation via the welding process.

### BRIEF DESCRIPTION OF THE DRAWINGS

Additional advantages, features and details of the invention may be gleaned from the following description of preferred exemplary embodiments, as well as based on the drawings:

The latter show:

FIG. 1: A schematic cross sectional view depicting a tubular body of a packaging tube with a exaggeratedly tapered circumferential section, in which two longitudinal edge faces of the film substrate forming the tubular body are joined together,

FIG. 2a: A section depicting a subsequent connecting area of a film substrate reshaped into a tubular body, wherein two beveled, vertically displaced edge faces of the film substrate abut each other, wherein use is made in the depicted exemplary embodiment of a three-layer, symmetrical film material, in which two barrier layer edge faces are spaced apart in the radial direction,

FIG. 2b: A section depicting the bonding of the film substrate into a tubular body through welding based on a situation according to FIG. 2a,

FIG. 3a: A situation during the formation of a tubular body out of a film substrate, in which two edge faces of the film substrate are arranged vertically displaced relative to each other so that the two barrier layer edge faces do not overlap, but rather linearly border each other in a radial direction,

FIG. 3b: A section of a tubular body of a packaging tube manufactured based on the situation according to FIG. 3a,

FIG. 4: A situation during the process of manufacturing a tubular body for a packaging tube, wherein the two edge faces of the film substrate are vertically displaced and abut each other in such a way that a barrier layer overlaps itself in a radial direction, and

FIG. 5: A section from a tubular body for a packaging tube, in which the barrier layer was compressed during production, thereby yielding a compressed or undulated shape of the barrier layer, wherein the barrier layer edge faces in the depicted exemplary embodiment do not overlap in a radial direction, but rather adjoin each other; in alternative embodiments that are not shown, the latter also overlap each other when in the compressed state, or are alternatively spaced apart from each other in a radial direction.

### DETAILED DESCRIPTION

On the figures, the same elements and elements with the same function are labeled with the same reference numbers.

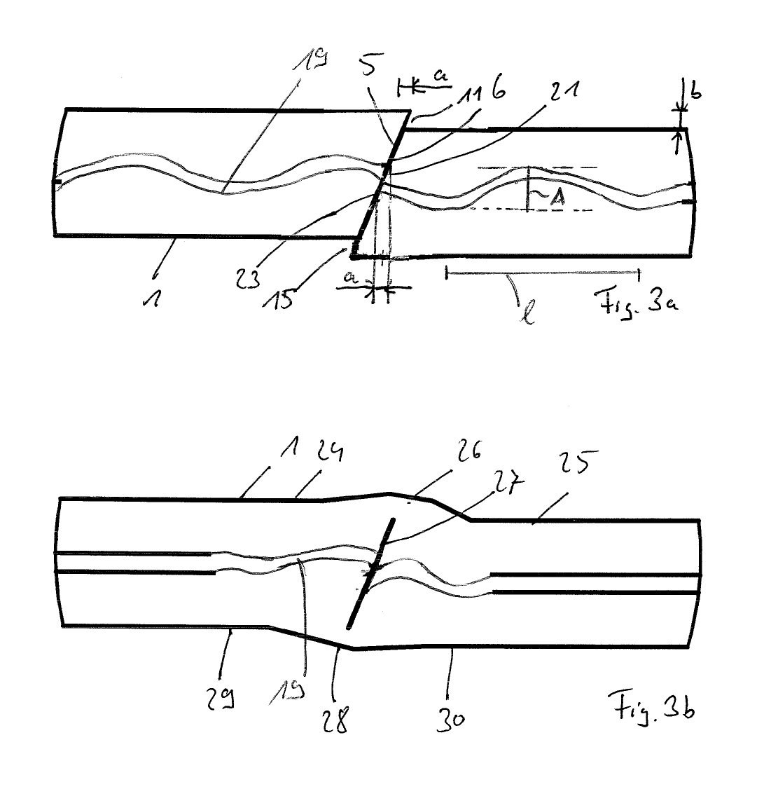

The wave geometry of the barrier layer is highly schematized on the figures. The schematic view according to FIG. 3a provides the definition of what is to be understood by a wavelength within the meaning of the invention, or by the radial distance between the maximum for a wave peak or the minimum for a wave valley immediately adjacent in the circumferential direction.

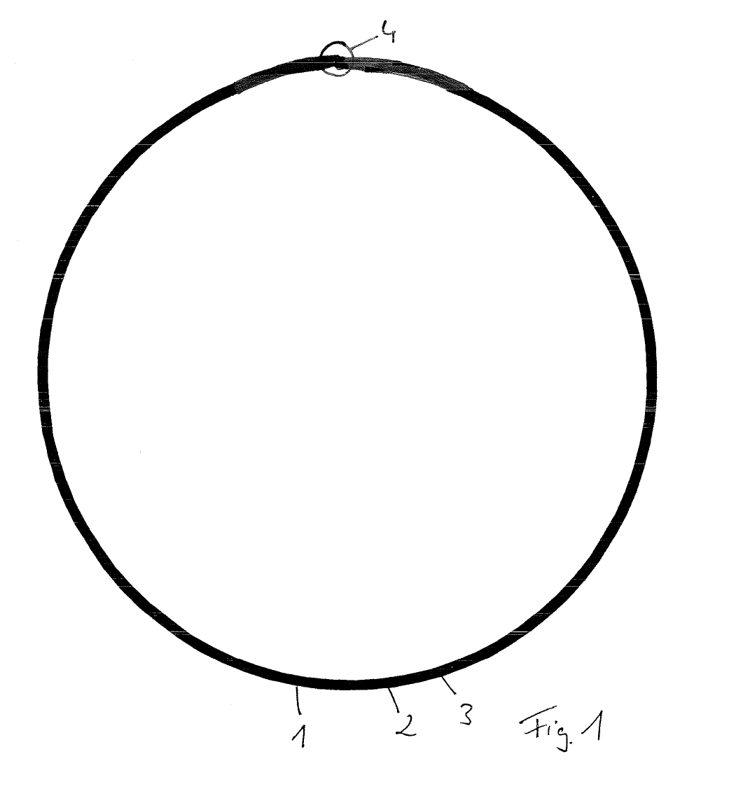

FIG. 1 presents a cross sectional view of a tubular body 1 with an essentially circular contour for a known packaging tube essentially comprised of plastic and not shown in any more detail. The tubular body 1 consists of one single- or multi-layer film substrate 2, encompassing or consisting of at least one weldable plastic layer 3.

In order to manufacture the tubular body 1, the strip-shaped film substrate 2 is molded into a cylindrical shape, wherein beveled edge faces not visible in detail on FIG. 1 are placed against each other, after which the film substrate is welded together to fix the tubular body 1 in the encircled area 4, wherein possible detailed views or embodiments of the area 4 (before and after welding) will be explained in greater detail in the following figures. For example, welding takes place so as to sandwich the area 4 between two sealing strips, which then are heated, in particular by means of an HF welding device, which leads at least to a partial melting of the film substrate 2 in the area 4. The welding station is preferably followed by a known cooling section for the weld seam to form (i.e., harden).

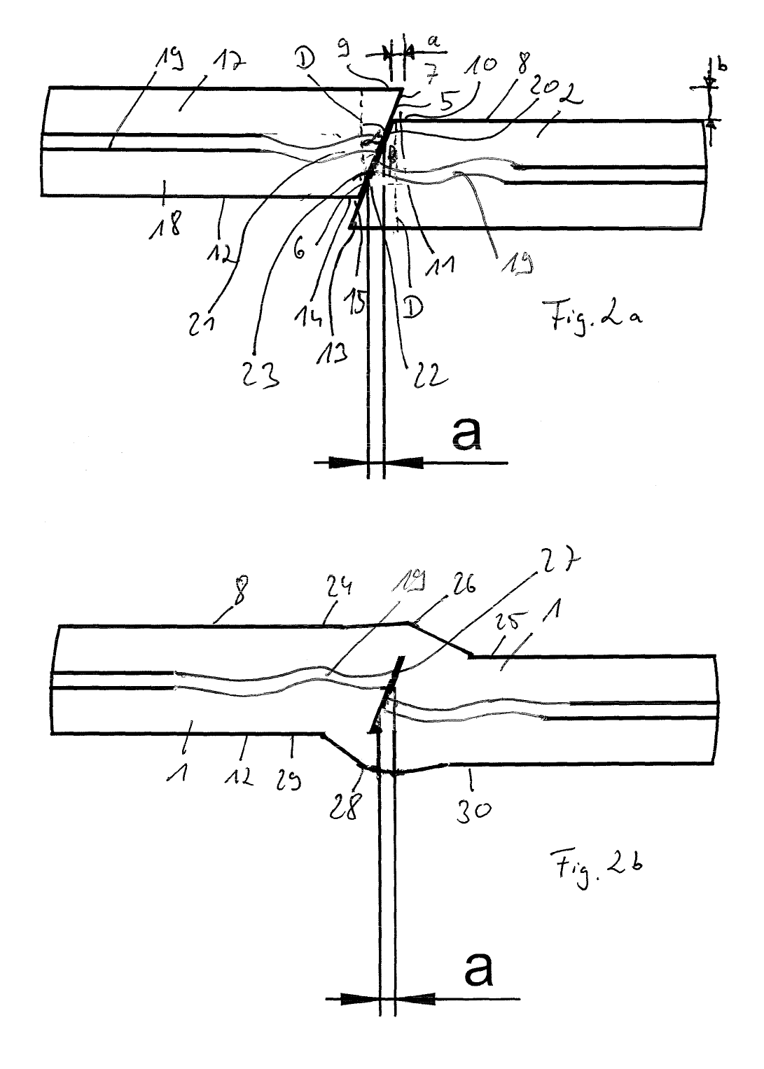

FIG. 2a depicts a possible situation prior to the welding step. The film substrate 2 has a three-layer configuration in the exemplary embodiment shown, and was shaped into a tubular body, for example by means of a molding strip and/or concave rollers, in such a way that an inclined first edge face 5 oriented in a first circumferential direction abuts in sections, i.e., only partially or not completely, against an opposing second, also inclined edge face 6. As may be gleaned from FIG. 2a, the barrier layer 19 is compressed in the circumferential direction, accompanied by the formation of a wave geometry.

As clearly evident from FIG. 2, the two edge faces 5, 6 are arranged vertically displaced relative to each other, so that the respective thickness centers (not shown) are vertically displaced in a radial direction. As a result, the first edge face with a radially outer area 7 projects over an outer circumferential surface 8 of the tubular body in the circumferential direction, toward the right here in the drawing plane, specifically by a distance measured in the circumferential direction a of between 0.05 mm and 0.3 mm in the exemplary embodiment shown. As put another way at the outset, this is the case, since a first outer circumferential surface edge section 9 that angularly borders the first edge face 5 is situated radially further to the outside relative to a longitudinal central axis of the tubular body (not shown) than a second outer circumference surface edge section 10, which angularly borders the second edge face 6. Expressed differently, the first and second outer circumferential surface edge sections 9, 10 are vertically displaced in a radial direction by a dimension b of 80 μm. Because the first edge face 5 is beveled, the depicted relative arrangement of the two edge faces 5, 6 forms an outer longitudinal gap 11 with an at least approximately triangular cross sectional contour between the first edge face 5, more precisely between the radially outer (projecting) area 7 (tip) and outer circumferential surface 8, more precisely the second outer circumferential surface edge section 10.

In the exemplary embodiment shown, the first edge face 5 forms an angle a of 30° with a thickness extension direction D of the film substrate 2. The second edge face 6 forms an angle β with the thickness extension direction D that corresponds to angle a in the exemplary embodiment shown.

As may further be gleaned from FIG. 2a, the second edge face 6 projects over the inner circumferential surface 12 in a circumferential direction opposite the circumferential direction in which the first edge face 5 projects over the outer circumferential surface 8, as a result of which an inner longitudinal gap 15 is formed between the second edge face 6, more precisely a radially inner area 13, and the inner circumferential surface 12, more precisely a first inner circumferential surface edge section 14 that angularly borders the first edge face 5. The first inner circumferential surface edge section 14 is arranged further to the outside in a radial direction, specifically by dimension b, than a second inner circumferential surface edge section 16, which borders the second edge face 6 and is angularly situated relative thereto.

The two longitudinal gaps 11, 15 are sealed in a subsequent welding process or at least partially filled with plastic material of the film substrate 2, accompanied by the formation of transitional sections yet to be discussed.

As mentioned, the film substrate 2 can consist entirely of a single, then weldable plastic layer. In the exemplary embodiment shown, the symmetrically configured film substrate 2 has three layers, and apart from an outer, here outermost, weldable plastic layer 17, encompasses an inner, here innermost, weldable plastic layer 18, wherein the two plastic layers 17, 18 in the exemplary embodiment shown exhibit the same thickness (which does not necessarily have to be the case), and sandwich a barrier layer 19, for example an aluminum layer, between them. As further evident from the exemplary embodiment shown, the barrier layer 19 overlaps itself in the circumferential direction by dimension a, which is measured between a radially outer boundary 20 of a first barrier layer edge face 21 and a radially inner boundary 22 of a second barrier layer edge face 23. In the exemplary embodiment shown, the first barrier layer edge face 21 is spaced apart from the second barrier layer edge face 23 in a radial direction, wherein this does not necessarily have to be the case, as will be explained further on, since they can also adjoin each other or overlap in a radial direction.

FIG. 2b shows a section of a finished, i.e., welded, tubular body 1. The sectional view reveals a vertical displacement (radial displacement) between a first outer circumferential surface section 24 (not deformed during welding) and a second outer circumferential surface section 25 spaced apart in the circumferential direction. The two outer circumferential surface sections 24, 25 lying on different radii are joined together by an outer transitional section 26, which arises during welding in the situation depicted on FIG. 2a. This outer transitional area 26 seamlessly, i.e., smoothly, joins together the two radially displaced outer circumferential surface sections 24, 25, and covers or overlaps a boundary area 27 or abutment area between the (original) edge faces, so that this connecting or boundary area does not linearly continue until up to the outer circumferential surface 8.

The tubular body 1 is analogously formed on the inner circumference. An inner transitional section 28 is there formed for the continuous joining of inner circumferential surface sections 29, 30 displaced in a radial direction.

In the exemplary embodiment shown, the outer transitional section 26 is formed by recooled plastic material of the first circumferential surface edge section 9 or possibly in part additionally by plastic material of the second circumferential surface edge section 10. The inner transitional section 28 is analogously formed by plastic material of the original, second inner circumferential edge section 16 and possibly plastic material of the first inner circumferential surface edge section 14.

Other alternative exemplary embodiments will be described below, wherein the focus will essentially be placed only on differences from the exemplary embodiments according to FIGS. 2a and 2b to avoid repetition.

The difference between the exemplary embodiment according to FIG. 2a and FIG. 3a lies solely in the fact that the first edge face 5 and second edge face 6 are not as vertically displaced, i.e., radially displaced; i.e., dimension b is smaller than in the exemplary embodiment according to FIG. 2a, and in the exemplary embodiment shown measures about 65 μm. The lower vertical displacement also yields a smaller overlapping distance a, which in the exemplary embodiment shown only measures 37.5 μm. As may be gleaned from FIG. 3a, an outer longitudinal gap 11 and inner longitudinal gap 15 still form, which are subsequently filled with melted plastic material to form a corresponding transitional section. As evident, the lower edge or lower boundary of the first barrier layer edge face 21 abuts against the upper boundary or upper edge of the second barrier layer edge face 23. There hence exists no radial distance, and the barrier layer edge faces 21, 23 also do not overlap each other in a radial direction.

As evident from FIG. 3a, the wavelength 1 measured from a minimum for a wave valley adjacent to the welding area to a minimum for the next wave valley in the circumferential direction equals 1=670 μm. The distance (radial distance A) between the minimum for the first wave valley relative to the welding area to the maximum for the adjoining wave peak measures A=66 μm in the exemplary embodiment shown. Assuming that the maximum deflection of the first wave valley corresponds to the maximum deflection (amplitude) of the adjacent wave peak, the latter measures 33 μm for both the wave valley and wave peak. Expressed differently, the radial distance between the maximum for the wave peak up to a zero diameter line measures 33 μm, just as the distance between the minimum for the wave valley and this zero diameter line.

FIG. 3b presents the situation according to FIG. 3a in a welded state. It reveals the outer transitional section 26 between the first outer circumferential surface section 24 and second outer circumferential surface section 25 situated radially further to the inside. Analogously, an inner transitional section 28 is formed between the first inner circumference surface section 29 situated radially further to the outside and the second inner circumferential surface section 30 situated radially further to the inside, as a result of which the boundary area 27 between the edge faces extends neither to the outer circumference nor to the inner circumference, but rather is covered on the outside in a radial direction by the outer transitional section 26, and on the inside by the inner transitional section 28 in the circumferential direction.

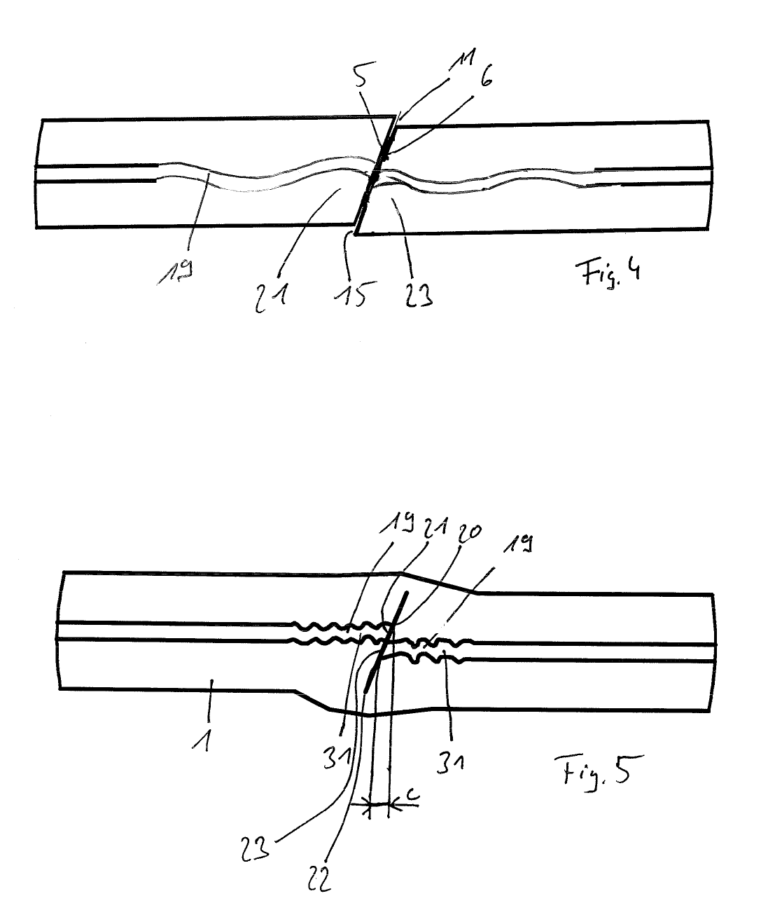

In the exemplary embodiment according to FIG. 4, an even smaller vertical or radial displacement is realized between the edge faces 5, 6 in the not yet welded state. The edge faces are arranged in such a way that the first barrier layer edge face 21 and second barrier layer edge face 23 overlap each other somewhat in a radial direction. Both the outer longitudinal gap 11 and inner longitudinal gap 15 are visible.

FIG. 5 shows a welded tubular body 1, wherein the edge faces 5, 6 in this case were pressed against each other so strongly as to compress the barrier layer 19, leading to the formation of a wave geometry 31. As may also be seen, the barrier layer 19 overlaps itself in the circumferential direction in such a way that a radially outer boundary 20 of the first barrier layer edge face 21 in the circumferential direction is spaced apart by distance c from the radially inner boundary 22 of the second barrier layer edge face 23 in the circumferential direction.

1. A method for manufacturing tubular bodies (1) exhibiting an inner circumferential surface and outer circumferential surface (8) for packaging tubes out of a strip-shaped film substrate (2) that encompasses a barrier layer (19), in particular against moisture and/or oxygen, exhibits at least one weldable plastic layer (3), and comprises a beveled first edge face (5) extending in the longitudinal direction of the film substrate (2) and a beveled second edge face (6) spaced apart from the first edge face (5) by the width of the film substrate (2), wherein the first edge face (5) and second edge face (6) are arranged opposite each other with the formation of a tube shape, and welded together during exposure to heat,
characterized in that
the first and second edge face (5, 6) are pressed against each other during welding so as to compress the barrier layer (19), accompanied by the formation of a wave geometry encompassing several wave peaks and/or several wave valleys.

2. The method according to claim 1,
characterized in that
the barrier layer (19) is compressed in such a way that the wave geometry exhibits at least three zero crossings and/or at least two equiphase zero crossings.

3. The method according to claim 2,
characterized in that
the first and second edge faces (5, 6) are pressed together with a pressure ranging between 0.1 and 4 N/m², preferably between 0.2 and 1 N/m², in particular as the welding area hardens.

4. The method according to one of the preceding claims,
characterized in that
the first and second edge faces (5, 6) are situated relative to each other in such a way that, prior to welding, the first edge face (5) projects over the outer circumferential surface (8) in the circumferential direction, so that an outer longitudinal gap (11) forms between the first edge face (5) and outer circumferential surface (8).

5. The method according to one of the preceding claims,
characterized in that
the first and second edge faces (5, 6) are situated relative to each other in such a way that the second edge face (6) projects over the inner circumferential surface of the film substrate (2) in the circumferential direction, so that an inner longitudinal gap (15) forms between the second edge face (6) and inner circumferential surface.

6. The method according to one of the preceding claims,
characterized in that
the edge faces (5, 6) are situated in such a way that the first edge face (5) projects over the outer circumferential surface (8) and/or the second edge face (6) projects over the inner circumferential surface (12) by a distance (a) measured in the circumferential direction ranging between 0.05 mm and 1.5 mm, preferably between 0.10 mm and 1.00 mm.

7. The method according to one of the preceding claims,
characterized in that
the edge faces (5, 6) are situated in such a way that the barrier layer (19) overlaps itself in the circumferential direction, preferably in such a way that a radially outer boundary (20) of a first barrier layer edge face (21) extending in the longitudinal direction of the film substrate (2) is spaced apart from a radially inner boundary (22) of a second barrier layer edge face (23) in the circumferential direction by between 0.05 mm and 1.50 mm, preferably between 0.10 mm and 1.00 mm.

8. The method according to claim 7,
characterized in that
the edge faces (5, 6) are situated relative to each other in such a way that the first and second barrier layer edge face (21, 23) overlap each other in a radial direction, or are spaced apart from each other in a radial direction, or directly border each other in a radial direction.

9. The method according to one of the preceding claims,
characterized in that
the edge faces (5, 6) are situated relative to each other in such a way that a first outer circumferential surface edge section (9) and second outer circumferential surface edge section (10) are vertically displaced to each other in a radial direction by between 10 μm and 300 μm, preferably by between 20 μm and 250 μm.

10. The method according to one of the preceding claims,
characterized in that
the first edge face (5) is situated at a first angle to a thickness extension direction (D) for the film substrate (2), and the second edge face (6) is situated at a second angle to the thickness extension direction (D) for the film substrate (2), and that the first angle and/or second angle preferably corresponding to the first angle are selected from an angular range of between 1° and 80°, preferably between 5° and 70°, even more preferably between 10° and 60°.

11. A packaging tube, in particular manufactured using one of the methods according to one of the preceding claims, with a tube head encompassing an outlet, which is secured to a tubular body (1) that encompasses at least one weldable plastic layer (3) and a barrier layer, in particular against moisture and/or oxygen, is manufactured through welding, and exhibits an outer circumferential surface (8) and inner circumferential surface (12),
characterized in that
at least sections of the barrier layer exhibit a wave geometry with at least two wave peaks and/or with at least two wave valleys.

12. The packaging tube according to claim 11,
characterized in that
the selected wavelength (1) for the wave geometry in at least one section, preferably a section adjacent to the welding area, ranges between 200 μm and 1800 μm, preferably between 400 μm and 1000 μm, eminently preferably between 500 μm and 700 μm.

13. The packaging tube according to one of claim 11 or 12,
characterized in that
the selected radial distance (A) between a maximum for a wave peak and a minimum for a wave valley immediately adjacent in the circumferential direction ranges between 30 μm and 90 μm, preferably between 40 μm and 70 μm.

14. The packaging tube according to one of claim 11 to 13,
characterized in that
a first outer circumferential surface section (24) extending in the longitudinal direction and the circumferential direction of the tubular pipe and a second outer circumferential surface section (25) extending in the longitudinal direction and the circumferential direction of the tubular pipe are vertically displaced in a radial direction, and that an outer transitional section (26) comprised of melted and recooled plastic layer material is formed in the circumferential direction between the vertically displaced outer circumferential surface sections (24, 25) as a continuous transition in the circumferential direction.

15. The packaging tube according to one of claim 11 to 14,
characterized in that
a first inner circumferential surface section (29) extending in the longitudinal direction and the circumferential direction of the tubular pipe and a second inner circumferential surface section (30) extending in the longitudinal direction and the circumferential direction of the tubular pipe are vertically displaced in a radial direction perpendicular to the circumferential extension, and that an inner transitional section (28) comprised of melted and recooled plastic layer material is formed in the circumferential direction between the vertically displaced inner circumferential surface sections (29, 30) as a continuous transition in the circumferential direction.

16. The packaging tube according to one of claim 11 to 15,
characterized in that
a boundary area (27) formed between the edge faces (5, 6) is covered on the outside in the circumferential direction by the outer transitional section (26) or by the first outer circumferential surface section (24) and/or that a boundary area (27) formed between the edge faces (5, 6) is covered on the inside in the circumferential direction by the inner transitional section (28) or by the second outer circumferential surface section (25).

17. The packaging tube according to one of claim 11 to 16,
characterized in that
the outer and/or inner transitional section (28) consists exclusively of melted plastic layer material of the film substrate (2), in particular an outermost or innermost plastic layer (17, 18).

18. The packaging tube according to one of claim 11 to 17,
characterized in that
the film substrate (2) consists of multiple layers and encompasses a barrier layer (19) against moisture and/or oxygen, and that the barrier layer (19) exhibits two barrier layer edge faces (21, 23) that extend in the longitudinal direction of the film substrate (2) and are oriented in opposite circumferential directions.

19. The packaging tube according to claim 18,
characterized in that
the barrier layer (19) overlaps itself in the circumferential direction, preferably by a distance measured in the circumferential direction ranging between 0.05 mm and 1.50 mm, preferably between 0.10 mm and 1.00 mm.
